(19) United States
(12) Patent Application Publication
(10) Pub. No.: US 2012/0058332 A1
(43) Pub. Date: Mar. 8, 2012

(54) BARRIER COATING MADE OF CYCLOOLEFIN COPOLYMERS

(75) Inventors: Kevin Müller, Heppenheim (DE); Ines Pietsch, Speyer (DE); Hermann Seyffer, Heidelberg (DE); Axel Weiss, Speyer (DE); Antje van der Net, Kassel (DE)

(73) Assignee: BASF SE, Ludwigshafen (DE)

(21) Appl. No.: 13/222,573

(22) Filed: Aug. 31, 2011

Related U.S. Application Data
(60) Provisional application No. 61/379,740, filed on Sep. 3, 2010.

(51) Int. Cl. B32B 3/00; B32B 27/10; B05D 7/00; B05D 3/00; B05D 7/02; B32B 27/08; B05D 5/00

(52) U.S. Cl. 428/336; 428/516; 428/511; 427/393.5; 427/391

(57) ABSTRACT

A barrier coating is described, where a polymer layer of thickness at least 1 μm is applied on a supportive substrate, selected from polymer foils, paper, and paperboard, and the polymer layer has been formed from a copolymer which can be produced via ring-opening metathesis polymerization of (a) olefin monomers, selected from monocyclic olefin monomers having 1 or 2 endocyclic C—C double bonds and bicyclic olefin monomers having an endocyclic C—C double bond, and (b) polycyclic olefin monomers having at least two C—C double bonds, e.g. a copolymer of cyclooctene and dicyclopentadiene.

The invention relates to barrier coatings of supportive substrates and to production of these, where a polymer layer has been applied on a supportive substrate and has been formed from a copolymer which can be produced via ring-opening metathesis polymerization (ROMP) of (a) olefin monomers, selected from monocyclic olefin monomers having 1 or 2 endocyclic C—C double bonds and bicyclic olefin monomers having an endocyclic C—C double bond, and (b) polycyclic olefin monomers having at least two C—C double bonds.

In the packaging or storage of products that require particular conditions it is important that the materials used for the package or container have the best possible barrier properties. The intention here is either to protect the packaged products from exterior effects such as gases, in particular oxygen or carbon dioxide, or atmospheric moisture, or to inhibit escape of constituents of the packaged products, examples being flavors, moisture, or fatty or oily substances.

By way of example, therefore, when packaging products that are sensitive to oxidation or to oxygen it is important that the packaging materials used have oxygen-barrier properties, i.e. that they minimize oxygen transmission or oxygen permeability.

Straight, uncoated polymer foils which are used as packaging materials and which are made by way of example of polyolefins, such as polyethylene or oriented polypropylene, or of polyesters, e.g. polyethylene terephthalate, generally exhibit relatively high oxygen permeability, and it is therefore necessary to improve the oxygen-barrier properties of the packaging materials by, for example, coating with specific, suitable polymers. Polymers used here are preferably those with high hydrophilicity, for example polyvinyl alcohol or polyacrylic acids. Said polymers exhibit a very good oxygen barrier under dry conditions, but drastic impairment of the barrier is observed under moist conditions, i.e. at humidities of about 85%. Some barrier coatings moreover do not have adequate flexibility. In that case, buckling or creasing in the region of folds can damage the barrier film and therefore lead to unsatisfactory barrier effects.

When products comprising oils or comprising fats are packaged, it is important that the packaging materials used have high resistance to penetration by fats and oils, or have good fat-barrier properties. There are various known processes which are suitable for providing packaging materials, in particular those based on paper or paperboard, with resistance to penetration by fats and by oils. To this end, the materials can by way of example be impregnated or coated with solutions or aqueous dispersions of natural or synthetic polymers, paraffins, waxes, or fluorinated hydrocarbons. Examples of these materials are solutions of starches and of starch derivatives, of galactomannans, of carboxymethylcelluloses, or of polyvinyl alcohols, or solutions of other synthetic polymers, for example of anionic polyacrylamides. A paper produced by this type of process has only a low level of fatproofing. There are also known processes where the paper, within or outside of the papermaking machine, is impregnated or coated with aqueous dispersions of polymers, paraffins, or waxes. There are also known processes where high resistance to penetration by fats and by oils is provided to papers by the extrusion-coating method, using melts of polymers, hotmelts, waxes, or paraffins. Fat-barrier coatings using polymer-based films often lack adequate flexibility. Creasing or folding at folds, e.g. edges or corners of folded boxes or cartons, can damage the barrier film and therefore lead to unsatisfactory fat-barrier effects,

Polymer foils, or other materials produced from organic polymers, often comprise what are known as plasticizers, in order to provide the desired flexibility to the materials. Plasticizers are particular, liquid or solid, inert organic substances with low vapor pressure, predominantly ester-type materials, where these interact physically with high-polymer substances, preferably, although not invariably, by using their solvating and swelling capability, and can thus form a homogeneous system with said substances. Plasticizers provide certain desired physical properties to the articles or coatings produced therewith, examples being depressed freezing point, increased moldability, improved elastic properties, or reduced hardness. They are classified as plastics additives, and are introduced into a material in order to improve its workability, flexibility, and extensibility, for example in flexible PVC. Examples of known, typical plasticizers are phthalates and trimellitates with (predominantly) linear C₆- to C₁₁-alcohols; other examples are dicarboxylic diesters. One particular plasticizer property which is often undesirable in plasticized-plastics applications is the tendency of the plasticizers to migrate; this is caused by processes related to diffusion, to vapor pressure, and to convection, and it is particularly noticeable when the plastic comes into contact with other liquid or solid substances, where the plasticizer penetrates into the other substance (these mostly being other plastics). The other substance becomes solvated or corroded, or swelling phenomena occur, and the final result can indeed be incipient adhesion to the surface of the contacting substance. Migration rate increases rapidly with temperature. In the case of adhesive applications, migration of plasticizers into the adhesive layer can undesirably reduce bond strengths, in particular at relatively high temperatures. Plasticizer migration can also be the cause of physiological hazard in packaging. It is therefore desirable to use a plasticizer barrier to counteract plasticizer migration from a material comprising plasticizer to the surface thereof or into adjacent layers and materials.

Ring-opening metathesis polymerization reactions are described in EP 1847558 A1 or in U.S. patent application 61/257,063. Homopolymers produced from cycloolefins via ring-opening metathesis polymerization and derived from cyclooctene or from cyclopentadiene are often brittle, thermoset materials or materials which do not form films, these being unsuitable for the formation of flexible coatings; or they have poor barrier properties, or the gloss transition temperature cannot be adjusted to the desired value.

It was an object of the present invention to provide further barrier coatings which permit the production of packaging or containers with good barrier properties, e.g. packaging for food or drink. These barrier coatings should have maximum resistance to temperature change, flexibility, and blocking resistance, and, as far as possible, they should not comprise any substances hazardous to health or to the environment, examples being fluorocarbon compounds. The coatings should moreover, as far as possible, exhibit barrier effects with respect to a plurality of exterior effects, for example a flavor barrier, a water-vapor barrier, a gas barrier (in particular oxygen barrier or CO₂ barrier), a fat barrier, and/or a plasticizer barrier.

The invention provides a barrier coating where at least one polymer layer of thickness at least 1 μm has been applied on a supportive substrate selected from polymer foils, paper, and paperboard, and the polymer layer has been formed from at least one copolymer, where this can be produced via ring-opening metathesis polymerization of

a) at least one olefin monomer, selected from the group consisting of monocyclic olefin monomers having one or two endocyclic C—C double bonds and bicyclic olefin monomers having an endocyclic C—C double bond, and

b) at least one polycyclic olefin monomer having at least two C—C double bonds; and the molar ratio of olefin monomers a) to polycyclic olefin monomers b) is from 80:20 to 15:85.

The invention also provides a process for producing or increasing a barrier effect on a supportive substrate, selected from polymer foils, paper, and paperboard, where at least one of the abovementioned copolymers, where these are described in more detail below, is applied at a layer thickness of at least 1 μm to the supportive substrate.

The invention also provides the use of the abovementioned copolymers, where these are described in more detail below, for producing or increasing a barrier effect on a supportive substrate, selected from polymer foils, paper, and paperboard.

The supportive substrate coated according to the invention with the copolymer has at least one barrier property, e.g. a fat barrier, an oxygen barrier, a water-vapor barrier, a plasticizer barrier, a flavor barrier, or a CO₂ barrier, where the coating of the invention produces the barrier property or increases its level. The expression barrier property means that transmission or, respectively, permeability with respect to certain substances has been reduced when comparison is made with an uncoated supportive substrate. Oxygen-barrier properties can by way of example be measured by the permeability test described in the examples. The oxygen transmission rate for polymer foils coated according to the invention is preferably less than 20% of the value for the uncoated polymer foil, in particular less than 10%, or less than 5%, e.g. from 0.1% to 3% (measured at 23° C. and 85% relative humidity).

Fat-barrier properties can by way of example be measured by the penetration test described in the examples. The expression “fat-barrier property” means that resistance of a substrate surface to the penetration of fats, of oils, and of fatty and oily, hydrophobic substances has been increased when comparison is made with uncoated substrate. The expression “plasticizer barrier” means that resistance of a substrate surface to the penetration of plasticizers has been increased when comparison is made with uncoated substrate.

The copolymers used in the invention can be produced via ring-opening metathesis polymerization. A metathesis reaction is very generally a chemical reaction between two compounds where a group is exchanged between two reactants. If this is an organic metathesis reaction, it can be formally represented as exchange of the substituents at a double bond. However, a particularly important reaction is the metal-complex-catalyzed ring-opening metathesis reaction of organic cycloolefin compounds (“ring opening metathesis polymerization”, abbreviated to ROMP), where this provides access to polyolefins. Catalytic metal complexes used are in particular metal carbene complexes of the general structure Met=CR2, where R is an organic moiety. The metal carbene complexes are very susceptible to hydrolysis, and the metathesis reactions can therefore be carried out in anhydrous organic solvents or in the olefins themselves (see by way of example U.S. Pat. No. 2,008,234451, EP-A 0824125). It is also possible to carry out the metathesis reaction of olefins in an aqueous medium in order to avoid complicated purification steps for the removal of large amounts of solvents or unreacted olefins (DE 19859191; U.S. patent application 61/257,063).

The copolymers used in the invention are formed from

a) at least one olefin monomer, selected from the group consisting of monocyclic olefin monomers having one or two endocyclic C—C double bonds and bicyclic olefin monomers having an endocyclic C—C double bond, and

b) at least one polycyclic olefin monomer having at least two C—C double bonds.

The molar ratio of olefin monomers a) to polycyclic olefin monomers b) is from 80:20 to 15:85, preferably from 65:35 to 20:80.

The ring strain of the olefin monomers a) is preferably at least 2 kcal/mol. The ring strain of the polycyclic olefin monomers b) is preferably at least 15 kcal/mol, based on the ring with the highest strain.

Examples of olefin monomers a) are cyclobutene, cyclopentene, 2-methylcyclopentene-1,3-methylcyclopentene-1,4-methylcyclopentene-1,3-butylcyclopentene-1, cyclohexene, 2-methylcyclohexene-1,3-methylcyclohexene-1,4-methylcyclohexene-1,1,4-dimethylcyclo-hexene-1,3,3,5-trimethylcyclohexene-1, cycloheptene, 1,2-dimethylcycloheptene-1, cis-cyclooctene, trans-cyclooctene, 2-methylcyclooctene-1,3-methylcyclooctene-1,4-methyl-cyclooctene-1,5-methyl-1-cyclooctene, cyclononene, cyclodecene, cycloundecene, cyclo-dodecene, cyclooctadiene, cyclopentadiene, cyclohexadiene and norbornene, and particular preference is given here to monocyclic olefins having one C—C double bond, in particular cis-cyclooctene.

Preferred polycyclic olefin monomers b) are bicyclic dienes, e.g. norbornadiene, dicyclopentadiene (3a,4,7,7a-tetrahydro-1H-4,7-methanoindene), bicyclo[2.2.2]octa-2,5-diene, bicyclo[3.3.0]octa-2,6-diene, and cyclopentadiene oligomers, e.g. tricyclopentadiene. Particular preference is given to dicyclopentadiene.

In one preferred embodiment, the copolymer has been formed via ring-opening metathesis polymerization of cis-cyclooctene and dicyclopentadiene.

The copolymers used in the invention are preferably produced in an aqueous medium. The ring-opening metathesis reaction here can be carried out by using water and dispersing agent as initial charge in a polymerization vessel, dissolving an organometallic carbene complex used as catalyst in the cycloolefin, introducing the cycloolefin/metal complex solution into the aqueous dispersing agent solution, converting the resultant cycloolefin/metal complex macroemulsion to a cyclocolefin/metal complex miniemulsion, and converting this at room temperature to an aqueous polyolefin dispersion. In a preferred method for carrying out the ring-opening metathesis reaction, at least one portion of the water, at least one portion of dispersing agent, and at least one portion of the monomers in the form of an aqueous monomer macroemulsion with an average droplet diameter≧2 μm are used as initial charge, and then the monomer macroemulsion is converted to a monomer miniemulsion with an average droplet diameter≦1500 nm, with introduction of energy, and then the optionally remaining residual amount of the water, the optionally remaining residual amount of the dispersing agent, the optionally remaining residual amount of the monomers, and the entire amount of an organometallic carbene complex used as catalyst are added to the resulting monomer miniemulsion at polymerization temperature.

Organometallic carbene complexes can be used as metathesis catalysts. Examples of metals are transition metals of the 6th, 7th, or 8th transition group, preferably molybdenum, tungsten, osmium, rhenium, or ruthenium, of which osmium and ruthenium are preferred. It is particularly preferable to use ruthenium alkylidene complexes. These metathesis catalysts are known from the prior art and are described by way of example in R. H. Grubbs (Ed.) “Handbook of Metathesis”, 2003, Wiley-VCH, Weinheim, WO 93/20111, WO 96/04289, WO 97/03096, WO 97/06185, J. Am. Soc. 1996, pp. 784-790, and in Coordination Chemistry Reviews, 2007, 251, pp. 726-764.

The concentration of the copolymers in the aqueous dispersions or solutions used for the coating process is preferably at least 1% by weight, in particular at least 5% by weight, and up to 50% by weight or up to 60% by weight. The content of the copolymers in the aqueous dispersion is mostly from 1 to 50% by weight or from 10 to 45% by weight, in particular from 15 to 40% by weight.

The viscosity of preferred aqueous dispersions of the copolymers at pH 4 and at a temperature of 20° C. is from 10 to 150 000 mPas, or from 200 to 5000 mPas (measured by a Brookfield viscosimeter at 20° C., 20 rpm, spindle 4). The average particle size of the copolymer particles dispersed in the aqueous dispersion is by way of example from 0.02 to 100 μm, preferably from 0.05 to 10 μm. It can be determined by way of example with the aid of optical microscopy, light scattering, or freeze-fracture electron microscopy.

The invention coats the supportive substrates with a solution or aqueous dispersion of at least one of the copolymers described above. Suitable substrates are in particular paper, paperboard, and polymer foils. The dispersions or solutions used for the coating process can comprise further additives or auxiliaries, examples being thickeners for rheology adjustment, wetting aids, or binders.

By way of example, a possible method of use on coating machinery applies the coating composition to paper or paperboard, or to a supportive foil made of a plastic. To the extent that materials in web form are used, the polymer dispersion is usually applied from a trough by way of an applicator roll and leveled with the aid of an airbrush.

Other successful ways of applying the coating use by way of example the reverse gravure process or spray processes, or use a doctor roller, or use other coating processes known to the person skilled in the art. The supportive substrate here has been coated on at least one side, i.e. it can have been coated monolaterally or bilaterally.

In order to achieve a further improvement in the adhesion on a foil, the supportive foil can be subjected in advance to a corona treatment. The amounts applied to the sheet-like materials are preferably by way of example from 1 to 10 g (of polymer, solid) per m², preferably from 2 to 7 g/m² in the case of foils and, respectively, preferably from 10 to 30 g/m² in the case of paper or paperboard. Once the coating compositions have been applied to the supportive substrates, the solvent is evaporated. To this end, it is possible by way of example in the case of continuous operation to guide the material through a drying tunnel, which can have an infrared irradiation device. The coated and dried material is then guided over a cooling roll and finally wound up. The thickness of the dried coating is at least 1 μm, preferably from 1 to 50 μm, particularly preferably from 2 to 30 μm.

The substrates coated by the invention exhibit excellent barrier effect with respect to oxygen and water vapor in the case of polymer foils, and excellent barrier effect with respect to fat and oils in the case of paper or paperboard. The coated substrates can be used as they stand, as means of packaging. The coatings have very good mechanical properties, and by way of example exhibit good blocking behavior, and exhibit in essence no cracking.

In order to obtain specific properties for the surfaces of, or for the coatings of, the foils and means of packaging, an example being good printability, or further improved sealing behavior, barrier behavior, or blocking behavior, or good water resistance, it can be advantageous to use outer layers as further layers on the coated substrates for additional provision of said desired properties, or to subject the barrier coating to a corona treatment. It is easy to apply further layers to the substrates precoated by the invention. A further layer can be applied by repeating a process stated above, or simultaneous multiple coating can be carried out in a continuous process without intermediate wind-up and unwind for example of the foil or the paper, for example by using a curtain coater. The location of the barrier layer of the invention is thus in the interior of the system, and the surface properties are then determined by the outer layer. The outer layer has good adhesion to the barrier layer.

The process described can easily produce barrier coatings, e.g. on foils made of oriented polypropylene or polyethylene, where the polyethylene can have been produced from ethylene either by the high-pressure polymerization process or by the low-pressure polymerization process.

Other suitable supportive foils are by way of example foils made of polyester, such as polyethylene terephthalate, and foils made of polyamide, polystyrene, and polyvinyl chloride. In one embodiment, the supportive material involves biodegradable foils, e.g. made of biodegradable aliphatic-aromatic copolyesters and/or polylactic acid, for example Ecoflex® foils or Ecovio® foils. Examples of suitable copolyesters are those formed from alkanediols, in particular C2-C8-alkanediols, e.g. 1,4-butanediol, and from aliphatic dicarboxylic acids, in particular C2-C8-dicarboxylic acids, e.g. adipic acid, and of aromatic dicarboxylic acids, e.g. terephthalic acid. Other suitable supportive materials are papers and paperboard. Supportive materials made of paper or paperboard are particularly preferred, in particular for production of coated folded boxes.

The thickness of the supportive foils is generally in the range from 10 to 200 μm, preferably being from 30 to 50 μm in the case of foils made of polyamide, preferably being from 10 to 40 m in the case of foils made of polyethylene terephthalate, preferably being about 10 to 100 μm in the case of foils made of polyvinyl chloride (in particular made of flexible PVC), and preferably being about 30 to 75 μm in the case of foils made of polystyrene.

In one embodiment of the invention, the copolymers of the invention are used in order to provide a plasticizer barrier to supportive materials. For the use as plasticizer barrier, the copolymers to be used in the invention are applied to the surface of a substrate which comprises at least one plasticizer. Plasticizers are particular, liquid or solid, inert organic substances with low vapor pressure, predominantly ester-type materials, where these interact physically with high-polymer substances, preferably by using their solvating and swelling capability without chemical reaction, and can thus form a homogeneous system with said substances. Plasticizers provide certain desired physical properties to the articles or coatings produced therewith, examples being depressed freezing point, increased moldability, improved elastic properties, or reduced hardness. They are classified as plastics additives, and are introduced into a material in order to improve its workability, flexibility, and extensibility, for example in flexible PVC.

Examples of preferred plasticizers are phthalates (e.g. dioctyl phthalate, diisononyl phthalate, diisodecyl phthalate; dibutyl phthalate, diisobutyl phthalate, dicyclohexyl phthalate; dimethyl phthalate, diethyl phthalate, mixed esters made of benzyl butyl phthalate, of butyl octyl phthalate, of butyl decyl phthalate, and of dipentyl phthalate, bis(2-methoxyethyl)phthalate, dicapryl phthalate, and the like); trimellitic esters with (predominantly) linear C₆-C₁₁-alcohols (e.g. tris(2-ethylhexyl)trimellitate); acyclic, aliphatic dicarboxylic esters (e.g. dioctyl adipate, diisodecyl adipate, dibutyl sebacate, dioctyl sebacate, decanedioic esters, or azelates); alicyclic dicarboxylic esters (e.g. diisononyl cyclohexanedicarboxylate), phosphoric esters (e.g. tricresyl phosphate, triphenyl phosphate, diphenyl cresyl phosphate, diphenyl octyl phosphate, tris(2-ethylhexyl)phosphate, tris(2-butoxyethyl)phosphate); citric esters, lactic esters, epoxy plasticizers, benzenesulfonamides, methylbenzenesulfonamides, and the like. Particularly preferred plasticizers are diisononyl cyclohexanedicarboxylate, dibutyl phthalate, diisononyl phthalate, and dinonyl undecyl phthalate.

The substrates comprising plasticizers preferably involve materials made of polyvinyl chloride (PVC, flexible PVC), i.e. a supportive substrate made of flexible PVC comprising plasticizer is provided with a barrier layer comprising a copolymer of the invention. The surface of the substrate here is coated at least to some extent with at least one layer which comprises at least one copolymer of the invention. In one preferred embodiment, the substrate involves a PVC foil comprising plasticizer. The PVC foil has been coated monolaterally or bilaterally, preferably monolaterally, with at least one copolymer of the invention.

In one embodiment of the invention, the barrier layer comprising the copolymer of the invention has also been coated completely or at least to some extent, either directly or not directly with an adhesive layer. The adhesive is preferably one selected from heat-sealable adhesives, cold-sealable adhesives, pressure-sensitive adhesives, hot-melt adhesives, radiation-crosslinkable adhesives, and heat-crosslinkable adhesives. By way of example, the invention provides a heat-sealable flexible PVC foil which comprises an exterior, heat-sealable layer where there is, between the supportive material made of flexible PVC and the heat-sealable layer, a barrier layer comprising at least one of the copolymers described above.

The invention also provides by way of example a self-adhesive flexible-PVC adhesive tape, where there is, between supportive material made of flexible PVC and exterior pressure-sensitive-adhesive layer, a barrier layer comprising at least one of the copolymers described above.

The coated substrates of the invention, comprising plasticizer, exhibit excellent barrier effect with respect to the migration of plasticizers. The coated substrates can be used as they stand, for example as elements in graphic art, or for lamination to furniture or to moldings in automobile construction, e.g. internal door cladding, or as packaging means, or as adhesive tapes. The coatings have very good mechanical properties and exhibit by way of example good blocking behavior and in essence no cracking.

### EXAMPLES

The following copolymer dispersions were used (monomer ratios are based on molar ratios):

### Dispersion D1:

30% strength aqueous poly(dicyclopentadiene-co-octenamer) dispersion, produced via ring-opening metathesis polymerization (ROMP) from dicyclopentadiene and cis-cyclooctene (50:50) with use of a ruthenium-alkylidene catalyst.

Number-average particle size: 270 nm

### Dispersion D2:

30% strength aqueous poly(dicyclopentadiene-co-octenamer) dispersion, produced via ring-opening metathesis polymerization (ROMP) from dicyclopentadiene and cis-cyclooctene (60:40) with use of a ruthenium-alkylidene catalyst.

### Dispersion D3:

30% strength aqueous poly(dicyclopentadiene-co-octenamer) dispersion, produced via ring-opening metathesis polymerization (ROMP) from dicyclopentadiene and cis-cyclooctene (70:30) with use of a ruthenium-alkylidene catalyst.

### Comparative Dispersion D4:

30% strength aqueous polyoctenamer dispersion, produced via ring-opening metathesis polymerization (ROMP) from cis-cyclooctene with use of a ruthenium-alkylidene catalyst.

Comparative Dispersion D5:

Acronal® S 504; 50% strength aqueous dispersion of an n-butyl acrylate/acrylonitrile/styrene copolymer

Determination of Oxygen Permeability of a Polyalkenamer Foil:

The foil was produced by casting a polyalkenamer dispersion into a silicone mold of dimensions 15 cm×10 cm×0.5 cm (length×width×height). The cast dispersion film was dried at 25° C. for 48 h and then heat-conditioned at a temperature of 65° C. for 10 minutes.

Dry and moist oxygen permeabilities were measured with a MOCON OXTRAN® 2/21, the measurement principle of which is based on the carrier-gas method (ASTM D3985). In the carrier-gas method, the masked specimen films (without supportive material) with a surface area which in this case is 5 cm² are incorporated into an airtight cell with a cavity on both sides. A carrier gas (95% of N₂ and 5% of H₂) is passed over one side of the specimen and the measurement gas (100% of O₂) is passed over the other side of the specimen, in both cases at atmospheric pressure. The measurement gas that diffuses through the specimen is absorbed by the carrier gas and conducted to a coulometric sensor. Oxygen concentration can thus be determined as a function of time. All measurements were carried out at 23° Celsius and at a defined relative humidity (RH). Both sides of the specimen were exposed to the defined humidity. Conditioning of the equipment and of the specimen took about half an hour. The machine running time for the measurements was from 1 to 4 days. Two determinations were carried out on each specimen. For the purposes of the tests, the transmission rate (cm³/(m²*day)) of the specimen was standardized by using to 1 μm and 1 bar, using the average thickness of the foil, which was measured at 5 different points. This standardization gave the permeation rate [cm³ μm/(m²*day*bar)].

A first measurement determined oxygen permeability under dry conditions. A second measurement determined oxygen permeability under moist conditions (85% relative humidity). Table 1 lists the results. The thickness of the foils was 386.8 μm.

TABLE 1
Oxygen permeability of a polyalkenamer foil

| | Transmission rate, | Permeation rate, | Transmission rate, | Permeation rate, |
|---|---|---|---|---|
| | 23° C., dry | 23° C., dry | 23° C., 85% RH | 23° C., 85% RH |
| Specimen | [cm³/(m²*day)] | [cm³μm/(m²*day*bar)] | [cm³/(m²*day)] | [cm³μm/(m²*day*bar)] |
| D1 | 0.272 | 104.8 | 0.254 | 98.247 |

### Determination of Water-Vapor Permeability of a Polyalkenamer Foil:

The foil was produced as described above. Water-vapor permeabilities were measured at 85% relative humidity by a MOCON PERMATRAN-W® 3/33, the measurement principle of which is likewise based on the carrier-gas method. The equipment operates in accordance with ASTM F1249. In the carrier-gas method, the masked specimen films (without supportive material) with a surface area which in this case is 5 cm² are incorporated into an airtight cell with a cavity on both sides. A carrier gas (dry N₂) is passed over one side of the specimen and the measurement gas (N₂+water vapor) is passed over the other side of the specimen, in both cases at atmospheric pressure. The measurement gas that diffuses through the specimen is absorbed by the carrier gas and conducted to a selective sensor. In the case of water-vapor-measurement equipment, an IR sensor is used. This permits determination of water-vapor concentration as a function of time. The measurements were carried out at 23° Celsius. Conditioning of the equipment took about 30 minutes. Machine running time for all of the measurements was from 1 to 4 days. The transmission rate of the specimen was measured with relative humidity adjusted with maximum precision to 85%, and the small metrological error in humidity adjustment was then computer-corrected. It was assumed here that there is a linear correlation between the transmission rate and the relative humidity within the range of measurement. For the purposes of the tests, the transmission rate (g/(m²*day)) of the specimen was standardized, using the average thickness of the foil, which was determined at 5 different points. This standardization gave the permeation rate (g*μm/(m²*day)). Table 2 lists the results. The thickness of the foils was 320 μm.

TABLE 2
Water-vapor permeability of a polyalkenamer foil

| | Transmission rate, | Permeation rate, |
|---|---|---|
| | 23° C., 85% RH | 23° C., 85% RH |
| Specimen | [g/(m²*day)] | [g*μm/(m²*day)] |
| D1 | 3.76 | 1203 |

### Determination of Water-Vapor Permeability of Barrier-Coated Paper:

The viscosities of the polyalkenamer dispersions D1 to D4 were adjusted to a range from 1000 to 1500 mPas by adding 2% of STEROCOLL® BL. A paper-coating machine was used to coat the dispersions onto single-side-precoated untreated paper (Magnostar, weight per unit area 70 g/m²), and this was followed by drying for 1 minute at 110° C. In order to monitor the amount applied, two specimens measuring 5 cm×5 cm were respectively punched out from the untreated paper and from the coated paper, and both were weighed, and the application weight per unit area was determined.

Round samples of diameter 90 mm were punched out from the material to be tested. The test specimens were placed on a small metal dish comprising dried silica gel in such a way that the coated side faced outward (toward the test medium). The side edges were sealed with a molten wax mixture. The wax edge was again melted by a small gas burner and thus homogenized. The edge of the dishes was then freed from wax residues by using a knife or by using petroleum ether and cotton waste. The dishes were weighed (initial value) and then stored at 23° C. and 85% relative humidity. After 24 h, the dishes were again weighed and the increase in weight was determined. This procedure was continued until the increase in weight was constant. After the specimens had been removed from the controlled-temperature/humidity cabinet, they were conditioned for 15 min at 23° C. and 50% relative humidity in a controlled-temperature/humidity chamber before they were weighed. Water-vapor permeabilities (WVP in g/(m²*day)) of the specimens were calculated from the following formula and are stated in table 3:

WVP=10⁴*dm/A

where
dm=difference in mass from the final constant weighings, in grams
A=test area of the specimen in cm²

TABLE 3
Water-vapor permeability of paper

| | Applied mass | Water-vapor permeability |
|---|---|---|
| Specimen | [g/m²] | [g/(m²*day)] |
| D1 | 14.0 | 45.1 |
| D2 | 14.7 | 54.0 |
| D3 | 12.7 | 55.8 |
| D4 (comparison) | 13.0 | 78.5 |
| D5 (comparison) | 14.1 | 342.2 |

### Determination of Oil Penetration of Barrier-Coated Paper:

A mixture of oleic acid and 0.5% of Sudan blue was used as test substance. The test substance was applied to the coated papers of dimensions 10×10 cm. These were then stored at a temperature of 60° C. After the periods stated in the table below, the percentage proportion of blue-colored grease spots was determined on the paper surface facing away from the test substance. The values stated in table 4 correspond to the approximate percentage of blue-colored surface area, and are a measure of the penetration of the test substance through the coated paper.

TABLE 4
Oil penetration of barrier-coated paper

| | Applied mass | Oil penetration | Oil penetration |
|---|---|---|---|
| Specimen | [g/m²] | after 1 hour [%] | after 16 hours[%] |
| D1 | 14.0 | 0 | 4 |
| D2 | 14.7 | 0 | 1 |
| D3 | 12.7 | 0 | 25 |
| D4 (comparison) | 13.0 | 0 | 79 |
| D5 (comparison) | 14.1 | 0 | 90 |

### Measurement of Oxygen-Barrier Effect:

Oxygen-barrier effect was measured by determining, at the respective relative humidity stated, oxygen transmission and, respectively, oxygen permeability of a biaxially oriented polypropylene foil (boPP foil) which had been coated with a poly(dicyclopentadiene-co-octenamer). This procedure measures oxygen permeability (transmission). The determination is carried out to ASTM D3985 by a coulometric sensor.

A polymer foil made of biaxially oriented polypropylene (boPP foil) of thickness 40 μm was coated with poly(dicyclopentadiene-co-octenamer) of dispersion D1 using a thickness of 16 μm, and stored for 7 days. The measurement was carried out at 23° C. using synthetic air (21% of oxygen), and the results were extrapolated to 100% of oxygen. Two determinations were carried out on each specimen. Oxygen-barrier effect was measured at 0% and 85% relative humidity.

The oxygen transmission rates over the uncoated boPP foil (40 μm) are:
0% RH: about 940 cm³/(m²*d)
85% RH: about 975 cm³/(m²*d)

Transmission for individual layers (A, B, . . . ) of a multilayer system is calculated as follows:

$$\frac{1}{{TR}_{total}} = \frac{1}{{TR}_{A}} + \frac{1}{{TR}_{B}} + Λ$$

### Specimen 1:

boPP foil (40 μm), coated with 16 μm of poly(dicyclopentadiene-co-octenamer) of dispersion 1 (molar monomer ratio 1:1, solids content 30%, particle size 270 nm).

### Specimen 2:

boPP foil (40 μm), coated with 16 μm of poly(dicyclopentadiene-co-octenamer) of dispersion 1 and then Corona-treated (about 2 sec, using 0.5 kW).

Table 5 collates the results.

TABLE 5
Oxygen-barrier effect of a coated boPP foil

| | Transmission rate of coating |
|---|---|
| Specimen | [cm³/(m²*day)] |
| Specimen 1 | 11.3 (0% RH) |
| | 148.9 (85% RH) |
| Specimen 2 | 6.0 (0% RH) |

1. A barrier coating where at least one polymer layer of thickness at least 1 μm has been applied on a supportive substrate selected from polymer foils, paper, and paperboard, and the polymer layer has been formed from at least one copolymer, where this can be produced via ring-opening metathesis polymerization of
a) at least one olefin monomer, selected from the group consisting of monocyclic olefin monomers having one or two endocyclic C—C double bonds and bicyclic olefin monomers having an endocyclic C—C double bond, and
b) at least one polycyclic olefin monomer having at least two C—C double bonds; and the molar ratio of olefin monomers a) to polycyclic olefin monomers b) is from 80:20 to 15:85.

2. The barrier coating according to the preceding claim, wherein the ring strain of the olefin monomers a) is at least 2 kcal/mol, and the polycyclic olefin monomers b) have been selected from bicyclic dienes whose ring strain is at least 15 kcal/mol.

3. The barrier coating according to any of the preceding claims, wherein the copolymer can be produced via ring-opening metathesis polymerization of cis-cyclooctene and dicyclopentadiene.

4. The barrier coating according to any of the preceding claims, wherein the supportive substrate is a polymer foil which has been produced from polyethylene terephthalate, from oriented polypropylene, from polyethylene, or from biodegradable aliphatic-aromatic copolyesters.

5. The barrier coating according to any of the preceding claims, wherein the supportive substrate is packaging or a portion of packaging.

6. The barrier coating according to any of the preceding claims, wherein the supportive substrate comprises plasticizer.

7. The barrier coating according to the preceding claim, wherein the supportive substrate is a PVC foil comprising plasticizer.

8. The barrier coating according to any of the preceding claims, wherein the barrier coating has also been coated with an adhesive layer, either directly or not directly.

9. A process for producing or increasing a barrier effect on a supportive substrate, selected from polymer foils, paper, and paperboard, where at least one copolymer layer of thickness of at least 1 μm is applied to the supportive substrate, and the copolymer can be produced via ring-opening metathesis polymerization of
a) at least one olefin monomer, selected from the group consisting of monocyclic olefin monomers having one or two endocyclic C—C double bonds and bicyclic olefin monomers having an endocyclic C—C double bond, and
b) at least one polycyclic olefin monomer having at least two C—C double bonds; and the molar ratio of olefin monomers a) to polycyclic olefin monomers b) is from 80:20 to 15:85.

10. The process according to the preceding claim, wherein the copolymer is applied in the form of an aqueous dispersion of the copolymer, and a film is formed via drying of the dispersion on the supportive substrate.

11. The process according to either of the two preceding claims, wherein the supportive substrate is a foil or packaging, and at least one portion of the surface of the packaging or of the foil has been coated with a film of the copolymer.

12. The use of a copolymer for producing or increasing a barrier effect on a supportive substrate, selected from polymer foils, paper, and paperboard, where the copolymer can be produced via ring-opening metathesis polymerization of
a) at least one olefin monomer, selected from the group consisting of monocyclic olefin monomers having one or two endocyclic C—C double bonds and bicyclic olefin monomers having an endocyclic C—C double bond, and
b) at least one polycyclic olefin monomer having at least two C—C double bonds;
and the molar ratio of olefin monomers a) to polycyclic olefin monomers b) is from 80:20 to 15:85.

13. The use according to the preceding claim, wherein the copolymer is used in the form of an aqueous dispersion of the copolymer for producing a barrier film.

14. The use according to either of the two preceding claims, wherein the barrier effect involves a fat barrier, an oxygen barrier, a water-vapor barrier, a plasticizer barrier, a flavor barrier, or a CO₂ barrier.

15. The use according to any of the preceding use claims, wherein an oxygen barrier or a water-vapor barrier is provided to polymer foils, or a fat barrier is provided to paper.
